(19) United States
(12) Patent Application Publication
(10) Pub. No.: US 2019/0057717 A1
(43) Pub. Date: Feb. 21, 2019

(54) NEAR-FIELD TRANSDUCER DIELECTRIC LAYER

(71) Applicant: Seagate Technology LLC, Cupertino, CA (US)

(72) Inventor: Weibin Chen, Bloomington, MN (US)

(21) Appl. No.: 15/679,368

(22) Filed: Aug. 17, 2017

(51) Int. Cl. G11B 5/60

(52) U.S. Cl. CPC G11B 5/6082; G11B 2005/0021

(57) ABSTRACT

An apparatus comprises a slider having an air bearing surface (ABS) that is configured for heat-assisted magnetic recording and comprises a write pole and a near-field transducer. The near-field transducer comprises a peg, an enlarged portion, and a dielectric layer. The peg has a front surface proximate the ABS, an opposing back surface, a top surface facing the write pole, two side surfaces, and a bottom surface opposing the top surface. The enlarged portion surrounds a portion of the peg including the back surface and has a front edge facing the ABS, wherein the distance from the ABS to the front edge is larger than the distance from the ABS to the front surface. The dielectric layer is disposed on a portion of the top surface of the peg and extends from the back surface of the peg to the front edge.

### SUMMARY

Embodiments of the disclosure are directed to an apparatus comprising a slider having an air bearing surface (ABS) and configured for heat-assisted magnetic recording. The slider comprises a write pole and a near-field transducer. The near-field transducer comprises a peg, an enlarged portion, and a dielectric layer. The peg has a front surface proximate the ABS, an opposing back surface, a top surface facing the write pole that extends from the front surface to the back surface, two side surfaces that extend from the front surface to the back surface, and a bottom surface opposing the top surface The enlarged portion surrounds a portion of the peg including the back surface. The enlarged portion also has a front edge facing the ABS, wherein the distance from the ABS to the front edge is larger than the distance from the ABS to the front surface of the peg. The dielectric layer is disposed on a portion of the top surface of the peg and extends from the back surface of the peg to the front edge of the enlarged portion.

Further embodiments are directed to an apparatus comprising a slider having an air bearing surface. The slider comprises a write pole and a near-field transducer. The near-field transducer comprises a peg, a disc portion, and a dielectric layer. The peg has a front surface proximate the ABS, an opposing back surface, a top surface facing the write pole that extends from the front surface to the back surface, two side surfaces that extend from the front surface to the back surface, and a bottom surface opposing the top surface. The disc portion surrounds a portion of the peg including the back surface. The disc portion has a front edge facing the ABS, wherein the distance from the ABS to the front edge is larger than the distance from the ABS to the front surface of the peg. The dielectric layer is disposed at the interface of the top surface of the peg and the disc portion.

Additional embodiments are directed to a method. The method includes depositing a layer of near-field transducer (NFT) peg material, and depositing a layer of dielectric material on the layer of NFT peg material. The layers are milled to form an NFT peg, and an enlarged NFT portion is formed around a portion of the NFT peg.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The discussion below refers to the following figures, wherein the same reference number may be used to identify the similar/same component in multiple figures. However, the use of a number to refer to a component in a given figure is not intended to limit the component in another figure labeled with the same number. The figures are not necessarily to scale.

FIG. 1 is a perspective view of a HAMR slider assembly according to embodiments discussed herein;

FIG. 2 is a cross-sectional view of a slider along a down-track plane, according to embodiments discussed herein;

FIG. 3A is a cross-sectional view of an example thermal gradient produced by a non-recessed near-field transducer according to embodiments discussed herein;

FIG. 3B is a cross-sectional view of an example thermal gradient produced by a recessed near-field transducer according to embodiments discussed herein;

FIG. 4 is a perspective view of a non-recessed near-field transducer according to embodiments discussed herein;

FIG. 5 is a perspective view of a non-recessed near-field transducer including a dielectric layer according to embodiments discussed herein;

FIG. 6 is a perspective view of a non-recessed near-field transducer including a dielectric layer according to embodiments discussed herein; and

FIG. 7 is a flow diagram illustrating how to form a dielectric layer on a non-recessed near-field transducer in accordance with various embodiments.

### DETAILED DESCRIPTION

The present disclosure is generally related to heat-assisted magnetic recording (HAMR), also referred to as energy-assisted magnetic recording (EAMR), thermally-assisted recording (TAR), thermally-assisted magnetic recording (TAMR), etc. In a HAMR device, a source of optical energy (e.g., a laser diode) is integrated with a recording head and couples optical energy to a waveguide or other light transmission path. The waveguide delivers the optical energy to a near-field transducer (NFT). The NFT concentrates the optical energy into a tiny optical spot in a recording layer of a magnetic recording medium, which raises the medium's temperature locally, reducing the writing magnetic field required for high-density recording.

Generally, the NFT is formed by depositing one or more thin-films of a plasmonic material such as gold, silver, copper, etc., at or near an integrated optics waveguide or some other light/energy delivery system. The laser light, delivered via the waveguide, generates a surface plasmon field on the portions of the NFT exposed to the light. The NFT is shaped such that the surface plasmons are directed out of a surface of the write head onto a magnetic recording medium.

Due to the intensity of the laser light and the small size of the NFT, the NFT and surrounding material are subject to a significant rise in temperature during writing operations. Over time, this can affect integrity of the NFT, for example, causing it to become misshapen and/or causing separation between portions of the NFT (e.g., the peg separates from the disc). Other events, such as contact between the read/write head and a recording medium, and/or with contamination on the recording medium, etc., may also degrade the operation of the NFT and nearby optical components. The high NFT temperatures thereby decrease the reliability of the HAMR read/write head and the effective service life of the head (i.e., the number of laser-on hours). In view of this, embodiments described herein are directed to improving the thermal gradient of the head and reducing the NFT temperature by introducing dielectric material proximate the NFT peg.

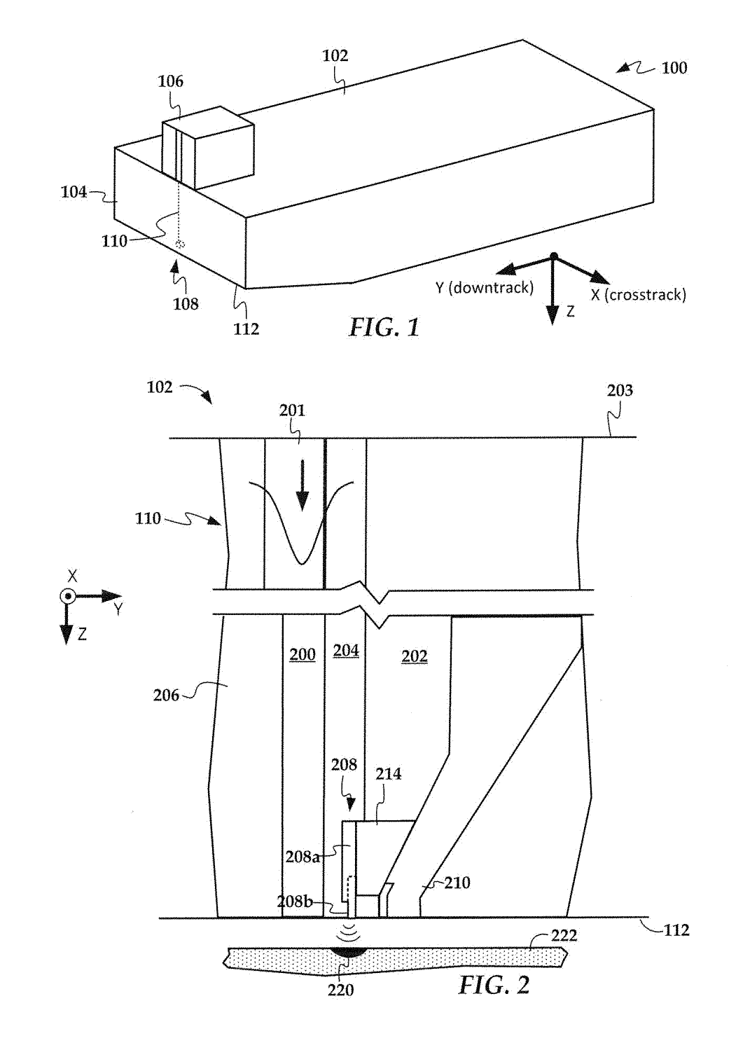

In reference now to FIG. 1, a perspective view shows a read/write head 100 according to an example embodiment. The read/write head 100 may be used in a magnetic data storage device, e.g., HAMR hard disk drive. The read/write head 100 may also be referred to herein interchangeably as a slider, head, write head, read head, recording head, etc. The read/write head 100 has a slider body 102 with read/write transducers 108 at a trailing edge 104 that are held proximate to a surface of a magnetic recording medium (not shown), e.g., a magnetic disk.

The illustrated read/write head 100 is configured as a HAMR device, and so includes additional components that form a hot spot on the recording medium near the read/write transducers 108. These HAMR components include an energy source 106 (e.g., laser diode) and a waveguide 110. The waveguide 110 delivers electromagnetic energy from the energy source 106 to a NFT that is part of the read/write transducers 108. The NFT achieves surface plasmon resonance and directs the energy out of a media-facing surface 112 to create a small hot spot in the recording medium.

In FIG. 2, a cross-sectional view shows details of a slider body 102 according to an example embodiment. The waveguide 110 includes a core 200, top cladding layer 202, side cladding layer 204, and bottom cladding 206. A waveguide input coupler 201 at a top surface 203 of the slider body 102 couples light from the light source 106 to the waveguide 110. The waveguide input coupler 201 receives light from the light source 106 and transfers the light to the core 200. The waveguide core 200 is made of dielectric materials of high index of refraction, for instance, AlN (aluminum nitride), Ta₂O₅ (tantalum oxide), TiO₂ (titanium oxide), Nb₂O₅ (niobium oxide), Si₃N₄ (silicon nitride), SiC (silicon carbon), Y₂O₃ (yttrium oxide), ZnSe (zinc selenide), ZnS (zinc sulfide), ZnTe (zinc telluride), Ba₄Ti₃O₁₂ (barium titanate), GaP (gallium phosphide), CuO₂ (copper oxide), and Si (silicon). The cladding layers 202, 204, 206 are each formed of a dielectric material having a refractive index lower than the core 200. The cladding can be, for instance, Al₂O₃ (alumina), SiO, and SiO₂ (silica).

The core 200 delivers light to an NFT 208 that is located within the side cladding layer 204 at the media-facing surface 112. A write pole 210 (which is a distal part of a magnetic write transducer) is located near the NFT 208. The magnetic write transducer may also include a yoke, magnetic coil, return pole, etc. (not shown). A heat sink 214 thermally couples the NFT 208 to the write pole 210. The magnetic coil induces a magnetic field through the write pole 210 in response to an applied current. During recording, an enlarged portion 208a (e.g., a rounded disc) of the NFT 208 achieves surface plasmon resonance in response to light delivered from the core 200, and the plasmons are tunneled via a peg 208b out of the media-facing surface 112. The energy delivered from the NFT 208 forms a hotspot 220 within a recording layer of a moving recording medium 222. The write pole 210 sets a magnetic orientation in the hotspot 220, thereby writing data to the recording medium.

As noted above, the NFT 208 reaches high temperatures during recording, and over time, this can cause instability. While the enlarged part 208a of the NFT 208 is generally formed from a material such as gold, the peg 208b may be formed from a high-melting-point material (e.g., greater than 1500° C.), such as a refractory metal (e.g., Rh, Ir, Pt, Pd, alloys thereof, etc.), to improve peg thermal stability. However, the peg 208b reaching high temperature repeatedly over time leads to poor structural integrity at the peg-to-disc (e.g., enlarged part) interface.

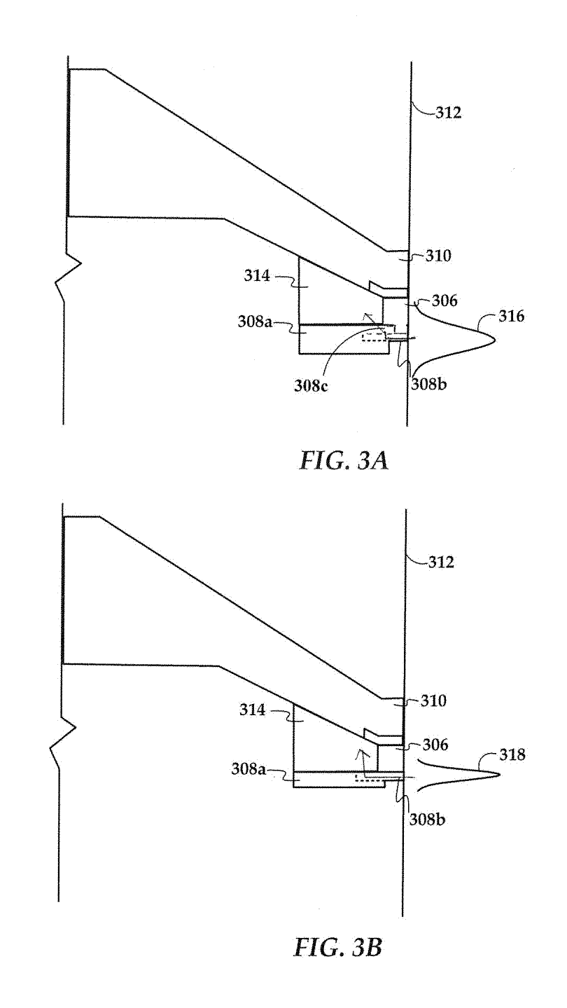

Different NFT designs can improve the structural integrity of the peg-to-disc interface; however, they also lead to a lower thermal gradient for the head. While the NFTs discussed herein have a peg and enlarged portion (e.g., disc) configuration, the NFT can have any variety of configurations that include a peg. FIGS. 3A-B illustrate the thermal gradient generated by various NFT designs. Both figures show an NFT proximate a write pole 310 at a slider ABS 312. The NFT includes a heatsink 314, an enlarged portion 308a, and a peg 308b. The layer 306 located between the peg 308b and the write pole 310 is referred to herein as the NFT to pole spacing (NPS) layer. In FIG. 3A, the enlarged portion 308a includes an overhang section 308c that extends along a surface of the peg 308b proximate the NPS layer 306. This configuration is referred to as a non-recessed NFT design. In FIG. 3B, the overhang section 308c is removed such that the peg 308b has an increased interface with the NPS layer 306. This is referred to as a recessed design. While the enlarged portion is shown as being larger in FIG. 3A as compared with FIG. 3B, this is to highlight the addition of the overhang section 308c. The figures are not to scale, and the remainder of the enlarged portion 308a can be the same size, or vary, between a non-recessed and recessed NFT design.

As shown by the arrow in FIG. 3A, heat generated by the peg 308b and/or reflected from the recording medium, flows through the NFT toward the heatsink 314. In FIG. 3A, heat travels through the peg 308b, into the overhang section 308c, and then into the heatsink 314. The light/heat path through the overhang section 308c increases background light contribution from the enlarged portion 308a to the NFT, which causes a lower thermal gradient 316 and is illustrated by the blooming or widening of gradient 316 along the ABS. This can result in a larger thermal spot on the recording medium and/or errors in reading or writing to the medium. Thus, a higher, sharper, or more focused, thermal gradient provides for more efficient writing/reading operations.

As shown by the arrow in FIG. 3B, reduction, or removal, of the overhang section 308c sharpens the thermal gradient 318. The removal of the heat conducting material (e.g., the overhang section 508c) removes the background optical field from the enlarged portion 308a and helps direct the heat path through the peg 308b toward the heatsink 314. The recessed design of FIG. 3B has a higher and more focused thermal gradient 318 as compared with the thermal gradient 316 of FIG. 3A. While the recessed NFT design has an improved thermal gradient 318, the design suffers from peg and disc (e.g., enlarged portion 308a) separation. Embodiments herein are directed to NFT designs having the structural integrity (e.g., design robustness) of the non-recessed design of FIG. 3A while providing the higher thermal gradient of the recessed design of FIG. 3B.

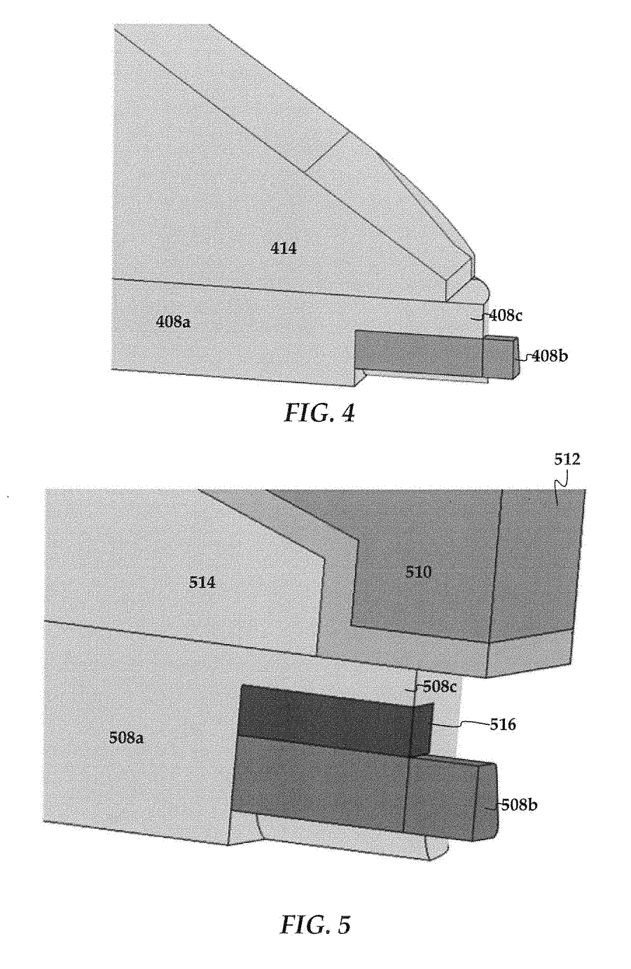

FIG. 4 is a perspective view of a non-recessed NFT design. The NFT comprises a heatsink 414, an enlarged portion 408a, an overhang section 408c, and a peg 408b. While the enlarged portion 408a, overhang section 408c, and heatsink 414 typically comprise the same material, e.g., gold Au, the peg 408 b can comprise the same, or a different material. For example, the peg 408b may comprise a high-melting-point material (e.g., greater than 1500° C.), such as a refractory metal (e.g., Rh, Ir, Pt, Pd, alloys thereof, etc.). In certain embodiments, the peg comprises rhodium. Since rhodium has a higher melting point than gold, an NFT with a rhodium peg can operate at higher temperatures than an NFT with a gold peg. Rhodium is also a useful peg material since it is hard and resistant to corrosion. Due to the increased amount of NFT enlarged portion material such as gold surrounding the peg (as compared with a recessed NFT design), the non-recessed NFT design experiences limited or no peg-disc separation. However, as discussed above, the non-recessed design generates a lower thermal gradient.

The non-recessed NFT design of FIG. 4 can be modified to effectively behave like a recessed NFT design by introducing dielectric material along the surface of the peg proximate the NPS, e.g., a top surface. FIG. 5 illustrates a perspective view of an NFT proximate an air-bearing surface (ABS) 512 in accordance with various embodiments described herein. The NFT includes a heatsink 514, enlarged portion 508a, overhang section 508c, peg 508b, and a dielectric layer 516. The NFT is proximate a write pole 510 and the NPS layer is not included to better illustrate the dielectric layer 516. The dielectric layer 516 is positioned along the surface of the peg 508b that faces the write pole 510 and is contained within the enlarged portion 508a. In certain embodiments, the dielectric layer 516 is sandwiched between the peg 508b and the overhang section 508c. The dielectric layer has a thickness (measured along the ABS in the downtrack direction) of about 10 to 30 nm, and a width (measured along the ABS in the crosstrack direction) that corresponds to the width of the peg 508b.

The dielectric layer 516 mimics the recessed NFT design by reducing the background optical field from the gold overhang section 508c. As can be seen when compared with the overhang section 408c of FIG. 4, the dielectric layer 516 reduces the thickness of the overhang section 508c. This increases the thermal gradient for the recording head to more closely match, or match, the thermal gradient of a recessed NFT design. The dielectric layer 516 can comprise any material with a refractive index less than 1.8. For example, the dielectric layer 516 can comprise AlₓO_{y} (alumina), SiO₂ (silica), SiNₓO_{y} (silicon oxynitride), yttria, TaSiOₓ, MgO, MgF₂, etc., or any combination thereof. The use of “x” and “y” subscripts represent multiple compounds having the same elements but varying numbers of atoms. The dielectric layer can also be a multi-layer structure. In certain embodiments, an adhesion layer (not shown) may also be included between the dielectric layer 516 and the NFT. For example, silica and gold do not adhere well to each other such that an alumina adhesion layer of about 1 to 3 nm may be disposed at any interfaces between the silica dielectric layer and the gold NFT. In other embodiments, an adhesion layer may also be disposed at the interface between the dielectric layer 516 and the peg 508b. With or without an adhesion layer, the structural integrity of the peg 508b and the enlarged portion 508a is improved as compared with a recessed NFT design due to the increased amount/volume of gold (or other enlarged portion material) proximate the peg 508b.

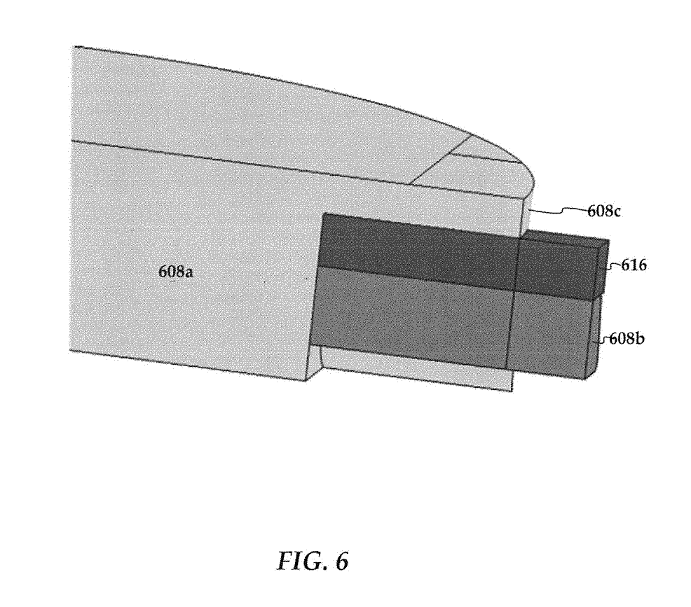

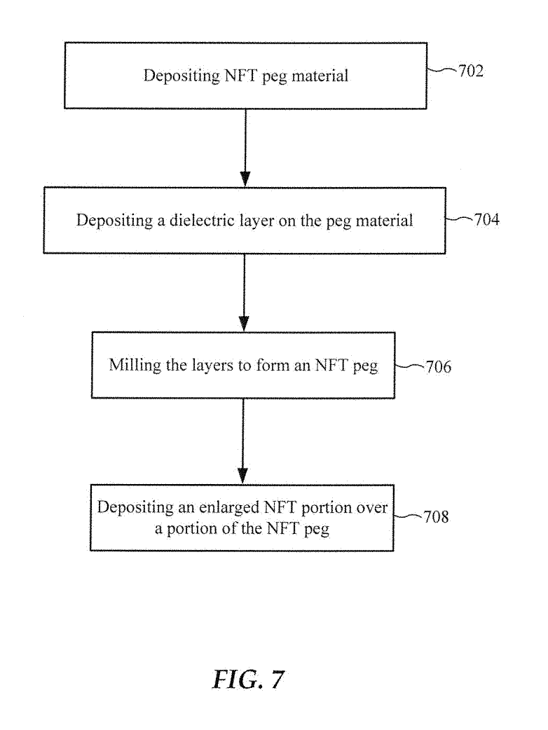

FIG. 6 is a perspective view of an NFT design with a dielectric layer according to further embodiments. Similar to the design of FIG. 5, the NFT includes enlarged portion 608a, overhang section 608c, peg 608b, and a dielectric layer 616. The heatsink, write pole, and NPS layer are omitted from the figure but would be positioned similar to the design of FIG. 5. As shown, the dielectric layer 616 is disposed along the top surface of the peg 608b that faces the write pole and extends the length/height of the peg 608b (as measured from the ABS into the slider/enlarged portion 608a). The dielectric layer 616 includes a portion interposed between the peg 508b and the overhang section 508c. As discussed above, the dielectric layer can comprise one or more of a variety of materials. When the dielectric layer 616 material differs from that of the NPS, the design resembles that of FIG. 6. When the dielectric layer 616 material is the same as that of the NPS, the design resembles that of FIG. 5. The dielectric layer 616 has a thickness (measured along the ABS in the downtrack direction) of about 10 to 30 nm, and a width (measured along the ABS in the crosstrack direction) that corresponds to the width of the peg 608b. This can be less than or one hundred percent of the thickness of the peg 608b.

Inclusion of a dielectric layer 616 in a non-recessed NFT design mimics the behavior of a recessed NFT design. Table 1 below shows respective measurements for an NFT with a dielectric layer as compared with the measurements of a baseline configuration, as shown in FIG. 4.

TABLE 1

| Configuration | Breakpoint (nm) | TG (K/nm) | Ieff (mA) | Peg T (K) |
|---|---|---|---|---|
| Baseline | 30 | 6.0 | 6.7 | 263 |
| FIG. 6 | 25 | 6.6 | 6.4 | 260 |

Table 1 shows the thermal gradient (TG), laser current efficiency (Ieff), and peg temperature (T) for a non-recessed NFT design having a dielectric layer, as described herein (FIG. 6), as compared with a non-recessed NFT design that does not (FIG. 4). The term breakpoint refers to a portion of the peg that extends from the enlarged portion of the NFT toward the ABS. The breakpoint is the position on the peg that is in contact with the enlarged portion of the NFT nearest to the ABS. For example, a break point of 30 nm indicates that 30 nm of the peg extends outward from the enlarged portion toward the ABS. Thus, assuming the total peg lengths are equal in the two designs of Table 1, more of the peg of FIG. 6, and therefore an increased portion of the dielectric layer, would be surrounded by the material (e.g., gold) of the NFT as compared with the baseline design. As can be seen, each of the metrics for the dielectric layer design is improved—increased thermal gradient, increased efficiency, and decreased peg temperature. In addition to the dielectric layer design providing improved performance and reliability comparable to a recessed NFT design, the dielectric layer design can be fabricated more easily.

An NFT with a dielectric layer as described herein can be fabricated using the same process as used for a non-recessed NFT design. In contrast with a recessed NFT fabrication process, chemical mechanical polishing of the peg is not necessary. The process involves depositing a layer of NFT peg material 702. The peg material can be a variety of high melting point materials, such as Rh (rhodium), and the peg material can be deposited in a layer of about 20 to 50 nm. Next, a layer of dielectric material is deposited on the layer of NFT peg material 704. The dielectric material can be a variety of materials as discussed above, such as AlₓO_{y} (alumina) or SiO₂ (silica), and the dielectric material can be deposited in a layer of about 10 to 30 nm. The layers are milled to form an NFT peg 706. The peg can be formed in a variety of sizes and shapes including having circular, rectangular, trapezoidal, etc. cross-sections and/or tapers or steps along the length. An enlarged NFT portion is then formed over/around a portion of the NFT peg 708. The enlarged portion can also be a variety of shapes and sizes including a circular or oval disc and/or including a heatsink portion proximate the disc. Thus, an NFT can be formed using a high-volume process and having the structural integrity of a non-recessed NFT design while also operating with a thermal gradient comparable to a recessed NFT design. An NFT with a dielectric layer can reduce the NFT operating temperature, reduce the amount of laser current needed for writing, and thereby extend the reliability and life of a recording head.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather, determined by the claims appended hereto.

1. An apparatus, comprising:
a slider having an air bearing surface (ABS) and configured for heat-assisted magnetic recording, the slider comprising:
a write pole; and
a near-field transducer comprising:
a peg, the peg having a front surface proximate the ABS, an opposing back surface, a top surface facing the write pole that extends from the front surface to the back surface, two side surfaces that extend from the front surface to the back surface, and a bottom surface opposing the top surface;
an enlarged portion surrounding a portion of the peg and including the back surface, the enlarged portion having a front edge facing the ABS, wherein the distance from the ABS to the front edge is larger than the distance from the ABS to the front surface of the peg; and
a dielectric layer disposed on a portion of the top surface of the peg, the dielectric layer extending from the back surface of the peg to the front edge of the enlarged portion.

2. The apparatus of claim 1, wherein the dielectric layer has a thickness between about 10 nm and 30 nm.

3. The apparatus of claim 1, wherein the dielectric layer comprises at least one of SiO₂, AlₓO_{y}, MgO, MgF₂, SiNₓO_{y}, TaSiOₓ, and yttria.

4. The apparatus of claim 1, wherein the peg comprises a refractory metal.

5. The apparatus of claim 1, wherein the front edge of the enlarged portion is about 20 to 40 nm from the ABS.

6. The apparatus of claim 1, wherein the NFT, when energized, produces a thermal gradient of at least 6.1 K/nm.

7. The apparatus of claim 1, wherein the dielectric layer extends from the back surface of the peg to the front surface of the peg.

8. An apparatus, comprising:
a slider having an air bearing surface (ABS), the slider comprising:
a write pole; and
a near-field transducer comprising:
a peg, the peg having a front surface proximate the ABS, an opposing back surface, a top surface facing the write pole that extends from the front surface to the back surface, two side surfaces that extend from the front surface to the back surface, and a bottom surface opposing the top surface;
a disc portion surrounding a portion of the peg and including the back surface, the disc portion having a front edge facing the ABS, wherein the distance from the ABS to the front edge is larger than the distance from the ABS to the front surface of the peg; and
a dielectric layer disposed at the interface of the top surface of the peg and the disc portion.

9. The apparatus of claim 8, wherein the dielectric layer has a thickness between about 10 nm and 30 nm.

10. The apparatus of claim 8, wherein the dielectric layer comprises at least one of SiO₂, AlₓO_{y}, MgO, MgF₂, SiNₓO_{y}, TaSiOₓ, and yttria.

11. The apparatus of claim 8, wherein the peg comprises a refractory metal.

12. The apparatus of claim 8, wherein the front edge of the enlarged portion is about 20 to 40 nm from the ABS.

13. The apparatus of claim 8, wherein the NFT, when energized, produces a thermal gradient of at least 6.1 K/nm.

14. The apparatus of claim 8, wherein the dielectric layer extends from the back surface of the peg to the front surface of the peg.

15. A method comprising:
depositing a layer of near-field transducer (NFT) peg material;
depositing a layer of dielectric material on the layer of NFT peg material;
milling the layers to form an NFT peg; and
forming an enlarged NFT portion around a portion of the NFT peg.

16. The method of claim 15, wherein the NFT peg material is Rh.

17. The method of claim 15, wherein the layer of NFT peg material has a thickness of between about 20 nm and 50 nm.

18. The method of claim 15, wherein the layer of dielectric material has a thickness of between about 10 nm and 30 nm.

19. The method of claim 15, wherein the enlarged NFT portion is a disc.

20. The method of claim 15, wherein the dielectric material is at least one of SiO₂, AlₓO_{y}, MgO, MgF₂, SiNₓO_{y}, TaSiOₓ, and yttria.
